(19) United States
(12) Patent Application Publication
(10) Pub. No.: US 2021/0237438 A1
(43) Pub. Date: Aug. 5, 2021

(54) INKJET PRINTER AND CONTROL METHOD OF INKJET PRINTER

(71) Applicant: MIMAKI ENGINEERING CO., LTD., Nagano (JP)

(72) Inventor: Yutaro Kishida, Nagano (JP)

(73) Assignee: MIMAKI ENGINEERING CO., LTD., Nagano (JP)

(21) Appl. No.: 17/160,386

(22) Filed: Jan. 28, 2021

(30) Foreign Application Priority Data
Jan. 31, 2020 (JP) 2020-014591

(51) Int. Cl. B41J 2/045; B41J 2/175; B41J 11/00

(52) U.S. Cl. CPC B41J 2/04563; B41J 2202/08; B41J 11/00214; B41J 2/175

(57) ABSTRACT

This inkjet printer includes a temperature sensor for detecting temperature of UV ink inside an inkjet head, and the inkjet head includes multiple piezoelectric elements that eject UV ink from each of a plurality of nozzles. In this inkjet printer, a controller that controls the inkjet printer constantly monitors temperature detected by the temperature sensor, and controls a drive voltage applied to the piezoelectric element in real time on the basis of a detection result of the temperature sensor so that a drive voltage applied to the piezoelectric element becomes low in response to a temperature rise detected by the temperature sensor.

### CROSS REFERENCE TO RELATED APPLICATIONS

This application claims the priority benefit of Japanese Patent Application No. 2020-014591, filed on Jan. 31, 2020. The entirety of the above-mentioned patent application is hereby incorporated by reference herein and made a part of this specification.

### TECHNICAL FIELD

The present disclosure relates to an inkjet printer that ejects UV ink, which is an ultraviolet-curable ink, to perform printing. The present disclosure also relates to a control method of such an inkjet printer.

### DESCRIPTION OF THE BACKGROUND ART

Conventionally, an inkjet printer (inkjet recording apparatus) including an inkjet head that ejects ink, a carriage on which the inkjet head is mounted, and a carriage drive mechanism that moves the carriage in a main scanning direction is known (e.g., see Japanese Unexamined Patent Publication No. 2007-160931, i.e., Patent Literature 1). In the inkjet printer described in Japanese Unexamined Patent Publication No. 2007-160931, a pressure chamber in which ink is housed and a plurality of nozzles communicating with the pressure chamber are formed in the inkjet head. The inkjet head includes a piezoelectric element that ejects ink from a nozzle by giving the pressure chamber energy for ejecting ink.

The inkjet printer described in Japanese Unexamined Patent Publication No. 2007-160931 includes a microcomputer, a ROM, a temperature sensor that detects the temperature of the inkjet head, and a drive IC that drives the piezoelectric element. The temperature sensor is attached to the inside or the outside or the vicinity of the inkjet head. The ROM stores a table to be referred to when the microcomputer determines the drive voltage of the piezoelectric element. In the table, different drive voltages are associated with respective head temperatures in a plurality of stages.

In the inkjet printer described in Japanese Unexamined Patent Publication No. 2007-160931, even if the temperature of the inkjet head rises during printing and the temperature of the ink in the inkjet head rises, resulting in a decrease in the viscosity of the ink ejected from the inkjet head, the drive voltage of the piezoelectric element is controlled by the following control method in order to suppress variations in the ejection amount and ejection speed of the ink ejected from the inkjet head and ensure the print quality.

That is, when the power is turned on, the inkjet printer described in Japanese Unexamined Patent Publication No. 2007-160931 detects the temperature of the inkjet head by the temperature sensor, and, with reference to the table stored in the ROM, sets, as the drive voltage of the piezoelectric element, the drive voltage associated with the temperature detected by the temperature sensor. When the drive voltage is set, the inkjet printer starts printing of the recording paper and drives the piezoelectric element with the set drive voltage. After starting of printing, the inkjet printer detects the temperature of the inkjet head by the temperature sensor when the carriage performs the scanning operation in the main scanning direction about five to ten times, resets the drive voltage of the piezoelectric element on the basis of the detection result of the temperature sensor, and then repeats the temperature detection of the inkjet head and the resetting of the drive voltage of the piezoelectric element until the printing of the recording paper ends.

Conventionally, an inkjet printer including an inkjet head that ejects UV ink, which is an ultraviolet-curable ink, a carriage on which the inkjet head is mounted, and a carriage drive mechanism that moves the carriage in a main scanning direction is known (e.g., see Japanese Unexamined Patent Publication No. 2015-168243, i.e., Patent Literature 2). In the inkjet printer described in Japanese Unexamined Patent Publication No. 2015-168243, a plurality of nozzles that eject UV ink and an ink flow path in which the plurality of nozzles are connected are formed in the inkjet head.

In the inkjet printer described in Japanese Unexamined Patent Publication No. 2015-168243, a film-like heater for heating UV ink ejected from the plurality of nozzles to reduce the viscosity of the ink is wound around the outer periphery of the inkjet head. The inkjet head includes a temperature sensor for detecting the temperature of ink in the ink flow path. The temperature sensor is disposed inside the inkjet head. The heater is controlled on the basis of the temperature detected by the temperature sensor. The inkjet head includes a drive unit that ejects ink from each of the plurality of nozzles.

Patent Literature 1: Japanese Unexamined Patent Publication No. 2007-160931

Patent Literature 2: Japanese Unexamined Patent Publication No. 2015-168243

Since the viscosity of UV ink (ultraviolet-curable ink) at room temperature is high and it is difficult to eject UV ink at room temperature from the inkjet head, it is necessary to raise the temperature of the UV ink to lower the viscosity of the UV ink in order to eject the UV ink from the inkjet head under a room temperature environment. There are various methods to lower the viscosity of UV ink to a viscosity with which the ink can be ejected. As in the inkjet printer described in Japanese Unexamined Patent Publication No. 2015-168243, the viscosity of UV ink is sometimes lowered by heating the UV ink before ejected from the inkjet head.

However, the viscosity of UV ink varies more sensitively with temperature variations than the viscosity of other types of inks such as solvent-based inks and water-based inks. That is, since the viscosity of UV ink greatly fluctuates with the temperature fluctuation, the fluctuation of the temperature of UV ink affects the volume and ejection speed of the UV ink ejected from the inkjet head, and causes a problem of deterioration in the print quality. Therefore, the inventor of the present disclosure has made clear that with an inkjet printer using UV ink, even if the drive voltage of the piezoelectric element is controlled by the control method of drive voltage of the piezoelectric element described in Japanese Unexamined Patent Publication No. 2007-160931, the problem of deterioration in print quality cannot be solved.

Specifically, with an inkjet printer using UV ink, if the temperature of the inkjet head rises and the temperature of the UV ink rises while the scanning operation of the carriage in a main scanning direction is performed about five to ten times, the viscosity of the UV ink is likely to greatly decrease. However, in the control method of the drive voltage of the piezoelectric element described in Japanese Unexamined Patent Publication No. 2007-160931, since the piezoelectric element is driven by the same drive voltage while the scanning operation of the carriage in the main scanning direction is performed about five to ten times, a situation may occur in which the piezoelectric element is driven at the same drive voltage even if the viscosity of the UV ink is largely decreased. Therefore, in the inkjet printer using UV ink, even if the drive voltage of the piezoelectric element is controlled by the control method of the drive voltage of the piezoelectric element described in Japanese Unexamined Patent Publication No. 2007-160931, there is a risk of deterioration of the print quality.

In the inkjet printer using UV ink, if the temperature of UV ink drops for some reason while the scanning operation of the carriage is performed in the main scanning direction for about five to ten times, the viscosity of the UV ink may increase significantly. However, in the control method of the drive voltage of the piezoelectric element described in Japanese Unexamined Patent Publication No. 2007-160931, since the piezoelectric element is driven by the same drive voltage while the scanning operation of the carriage in the main scanning direction is performed about five to ten times, a situation may occur in which the piezoelectric element is driven at the same drive voltage even if the viscosity of the UV ink is largely increased. Therefore, in the inkjet printer using UV ink, even if the drive voltage of the piezoelectric element is controlled by the control method of the drive voltage of the piezoelectric element described in Japanese Unexamined Patent Publication No. 2007-160931, there is a risk of deterioration of the print quality.

Therefore, the present disclosure provides an inkjet printer that can suppress deterioration of print quality due to temperature fluctuation of an inkjet head even when UV ink, which is an ultraviolet-curable ink, is used. The present disclosure provides a control method of an inkjet printer that can suppress deterioration of print quality due to temperature fluctuation of an inkjet head even when UV ink, which is an ultraviolet-curable ink, is used.

### SUMMARY

In order to solve the above problem, an inkjet printer of the present disclosure is an inkjet printer that ejects an UV ink, which is an ultraviolet-curable ink, to perform printing, including: an inkjet head configured to eject the UV ink; a temperature sensor configured to detect a temperature of the UV ink inside the inkjet head; and a controller configured to control the inkjet printer, in which a plurality of nozzles that eject the UV ink is provided in the inkjet head, the inkjet head includes a plurality of ejection energy generation elements configured to eject the UV ink from each of the plurality of nozzles, and the controller is configured to perform at least one of: constantly monitoring the temperature detected by the temperature sensor and controlling a drive voltage applied to the ejection energy generation elements in real time on the basis of a detection result of the temperature sensor so that the drive voltage applied to the ejection energy generation elements becomes low in response to a temperature rise detected by the temperature sensor, and constantly monitoring the temperature detected by the temperature sensor and controlling the drive voltage applied to the ejection energy generation elements in real time on the basis of a detection result of the temperature sensor so that the drive voltage applied to the ejection energy generation elements becomes high in response to a temperature drop detected by the temperature sensor.

In order to solve the above problem, a control method of an inkjet printer of the present disclosure is a control method of an inkjet printer, in which the inkjet printer includes: an inkjet head configured to eject an UV ink, which is an ultraviolet-curable ink; and a temperature sensor configured to detect a temperature of the UV ink inside the inkjet head, a plurality of nozzles that eject UV ink is provided in the inkjet head, and the inkjet head includes a plurality of ejection energy generation elements configured to eject the UV ink from each of the plurality of nozzles, and the control method performing at least one of: constantly monitoring the temperature detected by the temperature sensor and controlling a drive voltage applied to the ejection energy generation elements in real time on the basis of a detection result of the temperature sensor so that the drive voltage applied to the ejection energy generation elements becomes low in response to a temperature rise detected by the temperature sensor, and constantly monitoring the temperature detected by the temperature sensor and controlling the drive voltage applied to the ejection energy generation elements in real time on the basis of the detection result of the temperature sensor so that the drive voltage applied to the ejection energy generation elements becomes high in response to a temperature drop detected by the temperature sensor.

In the present disclosure, it is performed at least one of constantly monitoring the temperature detected by the temperature sensor and controlling the drive voltage applied to the ejection energy generation elements in real time on the basis of the detection result of the temperature sensor so that the drive voltage applied to the ejection energy generation elements becomes low in response to a temperature rise detected by the temperature sensor, and constantly monitoring the temperature detected by the temperature sensor and controlling the drive voltage applied to the ejection energy generation elements in real time on the basis of the detection result of the temperature sensor so that the drive voltage applied to the ejection energy generation elements becomes high in response to a temperature drop detected by the temperature sensor.

Therefore, in the present disclosure, when the temperature of the inkjet head rises and the temperature of the UV ink inside the inkjet head rises, resulting in a decrease in the viscosity of the UV ink, it becomes possible to immediately decrease the drive voltage applied to an ejection energy generation element in response to the temperature rise of the inkjet head, and when the temperature of the inkjet head drops and the temperature of the UV ink inside the inkjet head drops, resulting in an increase in the viscosity of the UV ink, it becomes possible to immediately increase the drive voltage applied to an ejection energy generation element in response to the temperature drop of the inkjet head.

When the temperature of the inkjet head rises and the viscosity of the UV ink inside the inkjet head decreases, it becomes possible to decrease the drive voltage applied to the ejection energy generation element in response to the temperature rise of the inkjet head even in the middle of performing the scanning operation of the carriage in the main scanning direction, and when the temperature of the inkjet head drops and the viscosity of the UV ink inside the inkjet head increases, it becomes possible to increase the drive voltage applied to the ejection energy generation element in response to the temperature drop of the inkjet head even in the middle of performing the scanning operation of the carriage in the main scanning direction.

Therefore, in the present disclosure, it becomes possible to suppress deterioration of print quality due to temperature fluctuation of an inkjet head even when UV ink, which is an ultraviolet-curable ink, is used. Note that, the “drive voltage” in the present description includes an effective voltage when the ejection energy generation element is subjected to pulse width modulation (PWM) control, in addition to the drive voltage when the ejection energy generation element is subjected to voltage control.

In the present disclosure, it is preferable that, the controller is configured to store a table having a plurality of temperatures detectable by the temperature sensor and the drive voltage associated in advance with each of the plurality of temperatures detectable by the temperature sensor, and the controller is configured to apply the drive voltage associated with the temperature detected by the temperature sensor to the ejection energy generation element. With this configuration, since the drive voltage associated with the temperature detected by the temperature sensor is applied to the ejection energy generation element as it is, it becomes possible to perform the processing in the controller in a short time.

In the present disclosure, it is preferable that, the inkjet head includes a heater configured to heat the inkjet head, the temperature sensor and the heater are incorporated in the inkjet head, and the controller is configured to control the heater on the basis of a detection result of the temperature sensor. With this configuration, it becomes possible to simplify the configuration of the inkjet printer, as compared with the case where a temperature sensor for controlling the heater is separately provided in addition to the temperature sensor for detecting the temperature of the UV ink inside the inkjet head.

In the present disclosure, the inkjet head includes a driver IC configured to drive the ejection energy generation element by applying the drive voltage to the ejection energy generation element, and the driver IC is incorporated in the inkjet head. When the driver IC is incorporated in the inkjet head, the temperature of the inkjet head tends to rise during printing, but, in the present disclosure, it becomes possible to suppress deterioration of print quality due to the temperature rise of the inkjet head even if the driver IC is incorporated in the inkjet head and the temperature of the inkjet head tends to rise during printing.

As described above, in the inkjet printer of the present disclosure, it becomes possible to suppress deterioration of print quality due to temperature fluctuation of an inkjet head even when UV ink, which is an ultraviolet-curable ink, is used. If the inkjet printer is controlled by the control method of the inkjet printer of the present disclosure, it becomes possible to suppress deterioration of print quality due to temperature fluctuation of an inkjet head even when UV ink, which is an ultraviolet-curable ink, is used.

### BRIEF DESCRIPTION OF THE DRAWINGS

FIG. 1 is a perspective view of an inkjet printer according to an embodiment of the present disclosure.

FIG. 2 is a schematic view for explaining the configuration of the inkjet printer shown in FIG. 1.

FIG. 3 is a perspective view of a part of a peripheral part of a carriage shown in FIG. 2.

FIG. 4 is a block diagram for explaining the configuration of the inkjet printer shown in FIG. 1.

FIG. 5 is a cross-sectional view for explaining a schematic configuration of the inkjet head shown in FIG. 2.

FIG. 6 is a view for explaining an example of a table stored in the controller shown in FIG. 4.

FIG. 7 is a cross-sectional view for explaining a schematic configuration of an inkjet head according to another embodiment of the present disclosure.

FIG. 8 is a graph for explaining the control method of an inkjet printer according to another embodiment of the present disclosure.

### DETAILED DESCRIPTION OF EMBODIMENTS

Embodiments of the present disclosure will be described below with reference to the drawings.

(Configuration of Inkjet Printer)

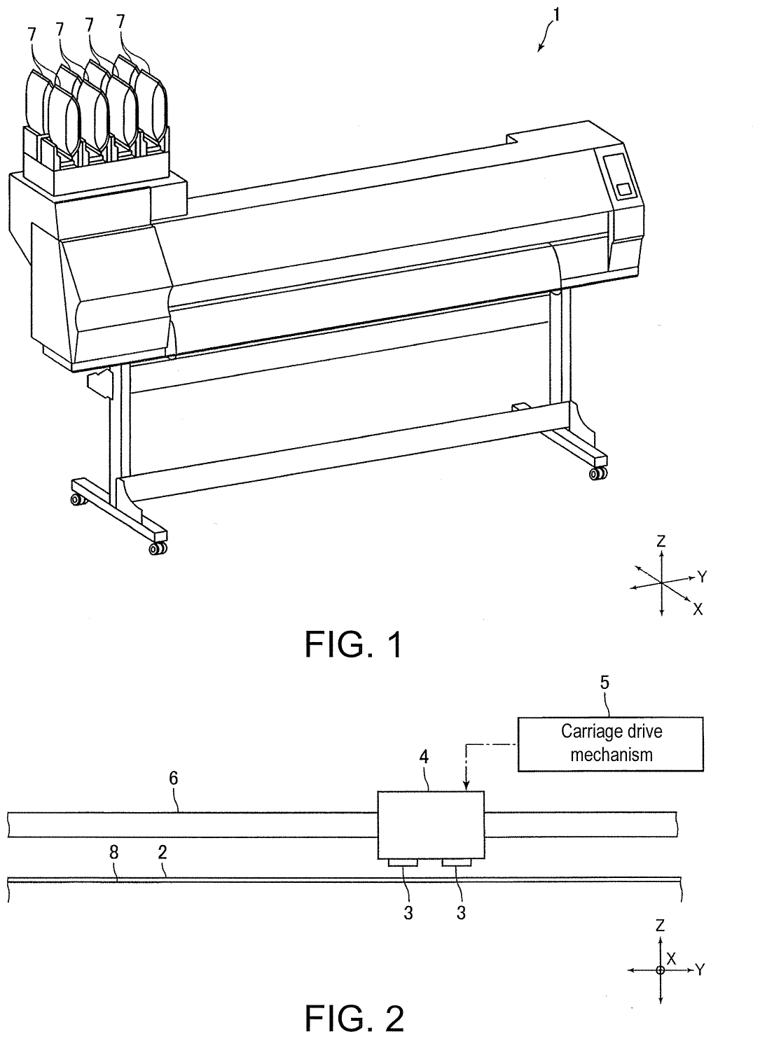

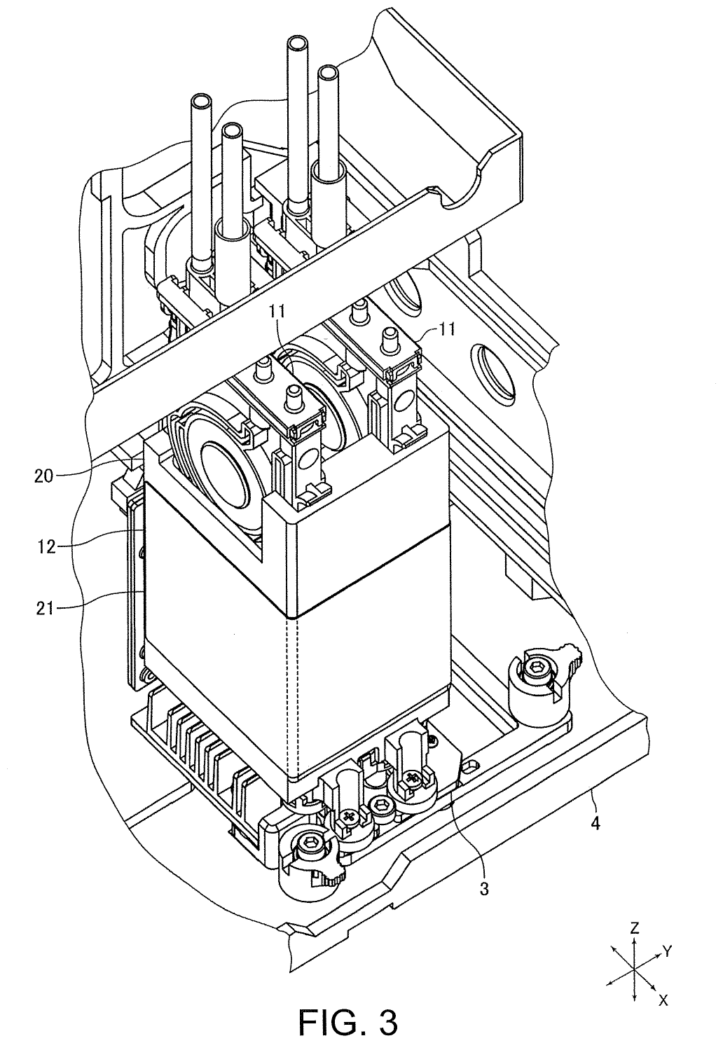

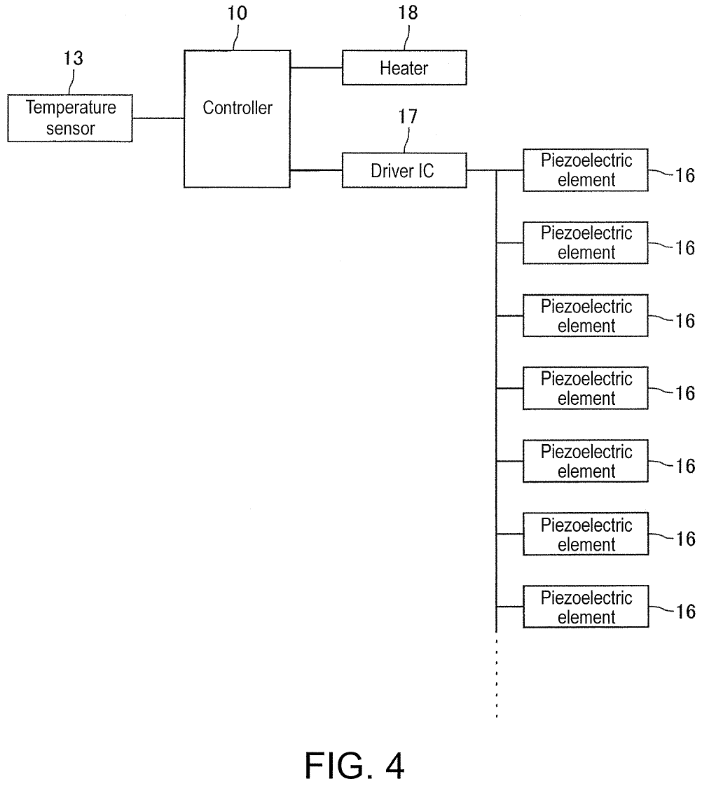

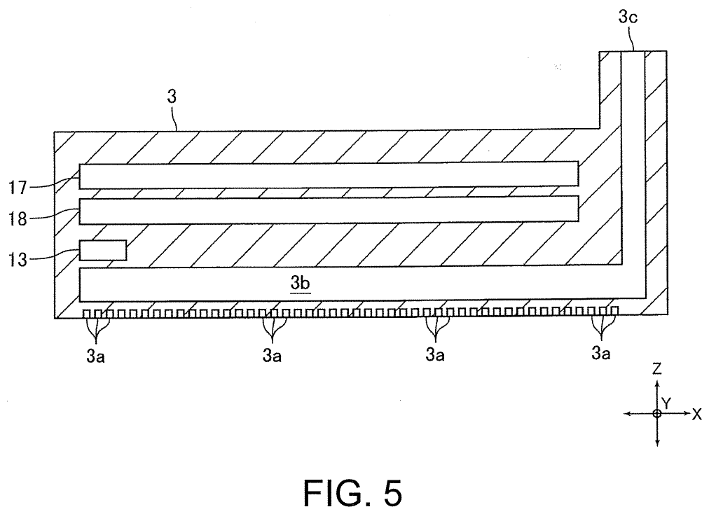

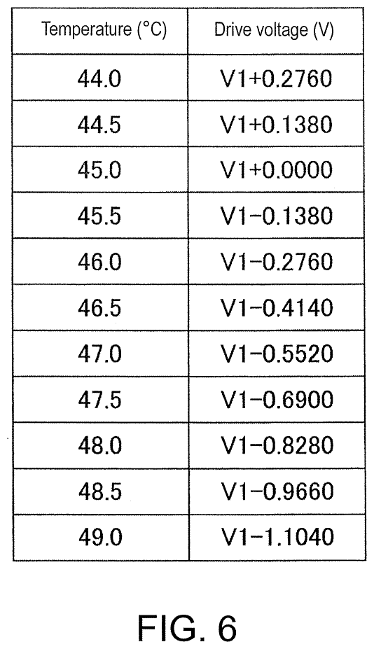

FIG. 1 is a perspective view of an inkjet printer 1 according to an embodiment of the present disclosure. FIG. 2 is a schematic view for explaining the configuration of the inkjet printer 1 shown in FIG. 1. FIG. 3 is a perspective view of a part of a peripheral part of a carriage 4 shown in FIG. 2. FIG. 4 is a block diagram for explaining the configuration of the inkjet printer 1 shown in FIG. 1. FIG. 5 is a cross-sectional view for explaining a schematic configuration of an inkjet head 3 shown in FIG. 2. FIG. 6 is a view for explaining an example of a table stored in a controller 10 shown in FIG. 4.

The inkjet printer 1 (hereinafter referred to as “printer 1”) of the present embodiment is an inkjet printer for business use, and ejects UV ink, which is an ultraviolet-curable ink, to perform printing on a print medium 2. The print medium 2 is a printing paper, a fabric, or a resin film. The printer 1 includes the inkjet head 3 (hereinafter referred to as “head 3”) that ejects UV ink toward the print medium 2, a carriage 4 on which the head 3 is mounted, a carriage drive mechanism 5 that moves the carriage 4 in a main scanning direction (Y direction in FIG. 1 and the like), a guide rail 6 for guiding the carriage 4 in the main scanning direction, and a plurality of ink tanks 7 in which the UV ink supplied to the head 3 is housed.

The printer 1 includes a pressure adjustment mechanism 11 for adjusting an internal pressure of the head 3, an ink heat mechanism 12 for heating the UV ink supplied to the head 3, and a temperature sensor 13 (hereinafter referred to as “head-side temperature sensor 13”) for detecting temperature of the UV ink inside the head 3. The printer 1 further includes the controller 10 that controls the printer 1. In the following description, the main scanning direction (Y direction) is defined as the “left-right direction” and a sub scanning direction (X direction in FIG. 1 and the like) orthogonal to the up-down direction (Z direction in FIG. 1 and the like) and the main scanning direction is defined as the “front-rear direction”.

The head 3 ejects UV ink downward. A plurality of nozzles 3a that eject UV ink are formed on the lower surface of the head 3. The plurality of nozzles 3a are arrayed in the front-rear direction, and the plurality of nozzles 3a arrayed in the front-rear direction constitute a nozzle row. The head 3 is formed with a plurality of ink flow paths 3b to which the plurality of nozzles 3a are connected. One end of the ink flow path 3b is an inlet port 3c into which ink flows from the ink heat mechanism 12. Note that, a plurality of nozzle rows are formed in the head 3, and the plurality of nozzle rows are arrayed in the left-right direction. The head 3 is formed with as many ink flow paths 3b as the nozzle rows.

A platen 8 is disposed below the head 3. The print medium 2 at the time of printing is placed on the platen 8. The print medium 2 placed on the platen 8 is conveyed in the front-rear direction by a medium feeding mechanism that is not illustrated. The carriage drive mechanism 5 includes two pulleys, a belt bridged over the two pulleys and partly fixed to the carriage 4, and a motor that rotates the pulleys.

The head 3 includes a plurality of piezoelectric elements 16 that eject UV ink from each of the plurality of nozzles 3a. The head 3 includes a driver integrated circuit (IC) 17 that applies drive voltage to the plurality of piezoelectric elements 16 to drive the plurality of piezoelectric elements 16, and a heater 18 that heats the head 3 (hereinafter referred to as “in-head heater 18”). The piezoelectric element 16, the driver IC 17, and the in-head heater 18 are disposed inside the head 3 and incorporated in the head 3. The in-head heater 18 is disposed below the driver IC 17. A heat insulating material, an insulating material, or the like is disposed between the driver IC 17 and the in-head heater 18. The driver IC 17 and the in-head heater 18 are electrically connected to the controller 10. The piezoelectric element 16 of the present embodiment is an ejection energy generation element.

The head-side temperature sensor 13 is a thermistor. The head-side temperature sensor 13 is disposed inside the head 3 and incorporated in the head 3. The head-side temperature sensor 13 is disposed above the other end (end opposite to one end of the ink flow path 3b where the inlet port 3c is formed) of the ink flow path 3b. The head-side temperature sensor 13 is disposed outside the ink flow path 3b. By detecting the temperature of the body frame of the head 3, the head-side temperature sensor 13 indirectly detects the temperature of the UV ink (specifically, the UV ink in the ink flow path 3b) inside the head 3. The head-side temperature sensor 13 is electrically connected to the controller 10.

By heating the body frame of the head 3, the in-head heater 18 heats the UV ink (specifically, the UV ink in the ink flow path 3b) inside the head 3, and thus performs the function of decreasing the viscosity of the UV ink inside the head 3. The controller 10 controls the in-head heater 18 on the basis of the detection result of the head-side temperature sensor 13. Specifically, the controller 10 drives the in-head heater 18 when the temperature detected by the head-side temperature sensor 13 is lower than a predetermined target setting temperature, and the in-head heater 18 is stopped when the temperature detected by the head-side temperature sensor 13 becomes equal to or higher than the target setting temperature.

Note that, the in-head heater 18 includes a temperature sensor (not illustrated) for detecting an overheat state of the in-head heater 18. This temperature sensor is a thermistor, and is attached to the in-head heater 18. This temperature sensor is attached to the upper surface of the in-head heater 18, and is disposed between the driver IC 17 and the in-head heater 18 in the up-down direction.

The pressure adjustment mechanism 11 is supplied with UV ink from the ink tank 7. Specifically, the ink tank 7 is disposed above the pressure adjustment mechanism 11, and UV ink is supplied from the ink tank 7 to the pressure adjustment mechanism 11 by a hydraulic head difference. The ink heat mechanism 12 is disposed between the pressure adjustment mechanism 11 and the head 3 in a supply path of UV ink to the head 3. The ink heat mechanism 12 is supplied with UV ink from the pressure adjustment mechanism 11, and the head 3 is supplied with UV ink from the ink heat mechanism 12. The pressure adjustment mechanism 11 and the ink heat mechanism 12 are mounted on the carriage 4.

The ink heat mechanism 12 is an out-of-head ink heat device disposed outside the head 3. By heating the UV ink supplied to the head 3, the ink heat mechanism 12 performs the function of decreasing the viscosity of the UV ink supplied to the head 3. The ink heat mechanism 12 is disposed above the head 3. The ink heat mechanism 12 includes a heat part body 20 formed in a block shape and a heater 21 affixed to the side surface of the heat part body 20. An ink flow path through which UV ink flows is formed inside the heat part body 20. The heater 21 is a sheet heater formed in a sheet shape.

The pressure adjustment mechanism 11 is attached to the ink heat mechanism 12. The lower part of the pressure adjustment mechanism 11 is housed in the heat part body 20. The pressure adjustment mechanism 11 is a mechanical pressure damper configured similar to the pressure adjustment damper described in Japanese Unexamined Patent Publication No. 2011-46070, and mechanically adjusts the internal pressure of the head 3 without using a pump for pressure adjustment. The pressure adjustment mechanism 11 adjusts the internal pressure of the head 3 (internal pressure of the ink flow path 3b) to a negative pressure.

As described above, in the printer 1, the in-head heater 18 is controlled on the basis of the detection result of the head-side temperature sensor 13, but the piezoelectric element 16 and the driver IC 17 are driven on the basis of the print data for printing on the print medium 2 regardless of the detection result of the head-side temperature sensor 13. Therefore, after printing of the print medium 2 is started, the longer the printing time becomes due to the continuous printing of the print medium 2, the higher than the target setting temperature the temperature detected by the head-side temperature sensor 13 gradually becomes under the influence of the heat generated by the piezoelectric element 16 and the heat generated by the driver IC 17.

That is, the longer the printing time of the print medium 2 becomes, the higher the temperature of the UV ink (UV ink in the ink flow path 3b) in the head 3 gradually becomes, and the more the viscosity of the UV ink ejected from the nozzle 3a decreases. Note that, the temperature rise of the UV ink in the head 3 is affected more by the heat generated by the driver IC 17 than by the heat generated by the piezoelectric element 16.

In the present embodiment, the controller 10 constantly monitors the temperature detected by the head-side temperature sensor 13 and controls the drive voltage applied to the piezoelectric element 16 in real time on the basis of the detection result of the head-side temperature sensor 13 so that the drive voltage applied to the piezoelectric element 16 becomes low in response to a temperature rise detected by the head-side temperature sensor 13 (i.e., so that the higher the temperature detected by the head-side temperature sensor 13 becomes, the lower the drive voltage applied to the piezoelectric element 16 becomes). Specifically, the controller 10 constantly monitors the temperature detected by the head-side temperature sensor 13, and, regardless of the temperature detected by the head-side temperature sensor 13, applies, to the piezoelectric element 16, the drive voltage decreased in real time on the basis of the detection result of the head-side temperature sensor 13 so that the amount of the UV ink ejected from the nozzle 3a and the ejection speed of the UV ink ejected from the nozzle 3a become substantially constant.

That is, the controller 10 constantly monitors the temperature detected by the head-side temperature sensor 13, and, regardless of the viscosity of the UV ink ejected from the nozzle 3a, applies, to the piezoelectric element 16, the drive voltage decreased in real time on the basis of the detection result of the head-side temperature sensor 13 so that the amount of the UV ink ejected from the nozzle 3a and the ejection speed of the UV ink ejected from the nozzle 3a become substantially constant. The controller 10 applies the drive voltage of the same magnitude to all of the piezoelectric elements 16 to be driven. Note that, the magnitude of the drive voltage applied to the piezoelectric element 16 sometimes changes depending on the temperature detected by the head-side temperature sensor 13, but the timing of application of the drive voltage to the piezoelectric element 16 does not change even if the temperature detected by the head-side temperature sensor 13 changes. That is, even if the temperature detected by the head-side temperature sensor 13 changes, the drive waveform of the piezoelectric element 16 is maintained.

In the present embodiment, the controller 10 stores a table having a plurality of temperatures detectable by the head-side temperature sensor 13 and drive voltages associated in advance with the plurality of respective temperatures detectable by the head-side temperature sensor 13 (see FIG. 6). The controller 10 applies the drive voltage associated with the temperature detected by the head-side temperature sensor 13 to the piezoelectric element 16.

In a case where the temperature detected by the head-side temperature sensor 13 is 45° C., the controller 10 applies a drive voltage V1 (V) associated with 45° C. to the piezoelectric element 16. In a case where the temperature detected by the head-side temperature sensor 13 is 45.5° C., the controller 10 applies a drive voltage V1-0.138 (V) associated with 45.5° C. to the piezoelectric element 16. Similarly, in a case where the temperature detected by the head-side temperature sensor 13 is 46° C., the controller 10 applies a drive voltage V1-0.276 (V) to the piezoelectric element 16, and, in a case where the temperature detected by the head-side temperature sensor 13 is 46.5° C., applies a drive voltage V1-0.414 (V) to the piezoelectric element 16. That is, as the temperature detected by the head-side temperature sensor 13 rises by 0.5 ° C., the controller 10 lowers the drive voltage applied to the piezoelectric element 16 in increments of 0.138 (V).

Note that, the amount of decrease in the applied voltage to the piezoelectric element 16 that decreases with a 0.5° C. increase in the temperature detected by the head-side temperature sensor 13 may be any value selected from the range of 0.1 to 0.145 (V). The controller 10 may lower the drive voltage applied to the piezoelectric element 16 in increments of any value selected from the range of 0.025 to 0.04 (V), as the temperature detected by the head-side temperature sensor 13 rises by any value selected from the range of 0.1 to 0.15 ° C. The controller 10 may lower the drive voltage applied to the piezoelectric element 16 in increments of 0.0276 (V), as the temperature detected by the head-side temperature sensor 13 rises by 0.1° C. (Main effect of the present embodiment)

As described above, in the present embodiment, the controller 10 constantly monitors the temperature detected by the head-side temperature sensor 13 and controls the drive voltage applied to the piezoelectric element 16 in real time on the basis of the detection result of the head-side temperature sensor 13 so that the drive voltage applied to the piezoelectric element 16 becomes low in response to a temperature rise detected by the head-side temperature sensor 13. Therefore, in the present embodiment, when the temperature of the head 3 rises and the temperature of the UV ink inside the head 3 rises, resulting in a decrease in the viscosity of the UV ink, it becomes possible to immediately decrease the drive voltage applied to piezoelectric element 16 in response to the temperature rise of the head 3.

In the present embodiment, when the temperature of the head 3 rises and the viscosity of the UV ink inside the head 3 decreases, it becomes possible to decrease the drive voltage applied to piezoelectric element 16 in response to the temperature rise of the head 3 even in the middle of performing the scanning operation of the carriage 4 in the main scanning direction. In the present embodiment, the controller 10, regardless of the temperature detected by the head-side temperature sensor 13, applies, to the piezoelectric element 16, the drive voltage decreased in real time on the basis of the detection result of the head-side temperature sensor 13 so that the amount of the UV ink ejected from the nozzle 3a and the ejection speed of the UV ink ejected from the nozzle 3a become substantially constant. Therefore, in the present embodiment, it becomes possible to suppress deterioration of print quality due to the temperature rise of the head 3 even if UV ink is used in the printer 1.

In the present embodiment in particular, since the driver IC 17 is incorporated in the head 3, the temperature of the head 3 tends to rise during printing the print medium 2 due to the influence of heat generated by the driver IC 17, but in the present embodiment, it becomes possible to suppress deterioration of print quality due to the temperature rise of the head 3 even if the temperature of the head 3 tends to rise during printing the print medium 2. Note that, the heat insulating material, the insulating material, or the like is disposed between the driver IC 17 and the in-head heater 18, but the heat generated by the driver IC 17 affects the temperature of the UV ink in the ink flow path 3b.

In the present embodiment, the controller 10 stores a table having a plurality of temperatures detectable by the head-side temperature sensor 13 and drive voltages associated in advance with the plurality of respective temperatures detectable by the head-side temperature sensor 13. The controller 10 applies the drive voltage associated with the temperature detected by the head-side temperature sensor 13 to the piezoelectric element 16 as it is. Therefore, in the present embodiment, it becomes possible to perform the processing in the controller 10 in a short time.

In the present embodiment, the controller 10 controls the in-head heater 18 on the basis of the detection result of the head-side temperature sensor 13. Therefore, in the present embodiment, it becomes possible to simplify the configuration of the printer 1, as compared with the case where a temperature sensor for controlling the in-head heater 18 is separately provided in addition to the head-side temperature sensor 13 for detecting the temperature of the UV ink inside the head 3.

(Variation of Control Method of Inkjet Printer)

In the above-described embodiment, the controller 10 constantly monitors the temperature detected by the head-side temperature sensor 13 and controls the drive voltage applied to the piezoelectric element 16 in real time on the basis of the detection result of the head-side temperature sensor 13 so that the drive voltage applied to the piezoelectric element 16 becomes low in response to a temperature rise detected by the head-side temperature sensor 13. However, in addition to this control or in place of this control, the controller 10 may constantly monitor the temperature detected by the head-side temperature sensor 13 and control the drive voltage applied to the piezoelectric element 16 in real time on the basis of the detection result of the head-side temperature sensor 13 so that the drive voltage applied to the piezoelectric element 16 becomes high in response to a temperature drop detected by the head-side temperature sensor 13 (i.e., so that the drive voltage applied to the piezoelectric element 16 becomes high, as the temperature detected by the head-side temperature sensor 13 becomes low).

Also in this case, the controller 10 applies the drive voltage associated with the temperature detected by the head-side temperature sensor 13 to the piezoelectric element 16 on the basis of the table shown in FIG. 6. In a case where the temperature detected by the head-side temperature sensor 13 is 45° C., the controller 10 applies a drive voltage V1 (V) associated with 45° C. to the piezoelectric element 16. In a case where the temperature detected by the head-side temperature sensor 13 is 44.5° C., the controller 10 applies a drive voltage V1+0.138 (V) associated with 44.5° C. to the piezoelectric element 16. In a case where the temperature detected by the head-side temperature sensor 13 is 44° C., the controller 10 applies a drive voltage V1+0.276 (V) associated with 44° C. to the piezoelectric element 16.

In this case, when the temperature of the head 3 drops and the temperature of the UV ink inside the head 3 drops, resulting in an increase in the viscosity of the UV ink, it becomes possible to immediately increase the drive voltage applied to piezoelectric element 16 in response to the temperature drop of the head 3. When the temperature of the head 3 drops and the viscosity of the UV ink inside the head 3 increases, it becomes possible to increase the drive voltage applied to piezoelectric element 16 in response to the temperature drop of the head 3 even in the middle of performing the scanning operation of the carriage 4 in the main scanning direction. Therefore, regardless of the temperature detected by the head-side temperature sensor 13, by applying, to the piezoelectric element 16, the drive voltage increased in real time on the basis of the detection result of the head-side temperature sensor 13 so that the amount of the UV ink ejected from the nozzle 3a and the ejection speed of the UV ink ejected from the nozzle 3a become substantially constant, it becomes possible to suppress deterioration of print quality due to the temperature drop of the head 3 even if UV ink is used in the printer 1.

### Other Embodiments

Although the above-described embodiment is an example of a preferred embodiment of the present disclosure, the present disclosure is not limited thereto, and various modifications can be made without changing the scope of the present disclosure.

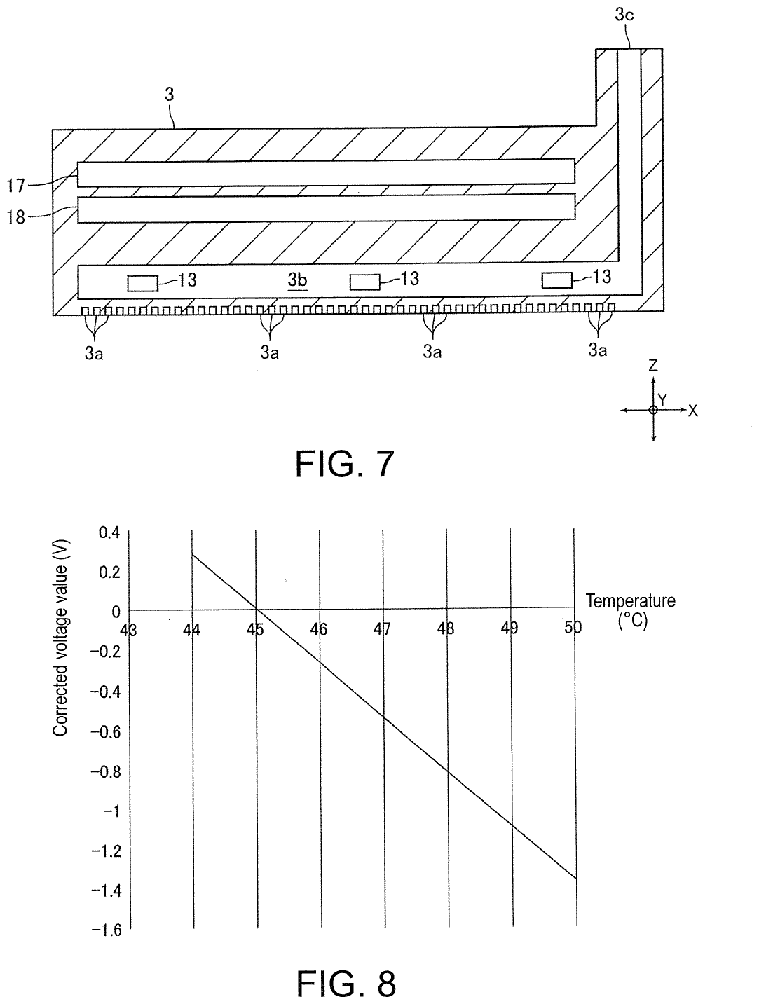

In the above-described embodiment, as shown in FIG. 7, the head-side temperature sensor 13 may be disposed at a position in contact with the UV ink in the ink flow path 3b, and may directly detect the temperature (i.e., the temperature of the UV ink inside the head 3) of the UV ink in the ink flow path 3b. In this case, it becomes possible to accurately detect the temperature of the UV ink inside the head 3 by the head-side temperature sensor 13. In the above-described embodiment, the head-side temperature sensor 13 may be disposed outside the head 3 as long as the head-side temperature sensor 13 can appropriately detect the temperature of the UV ink inside the head 3. Note that, in the example shown in FIG. 7, the three head-side temperature sensors 13 are disposed at positions in contact with the UV ink in the ink flow path 3b, but the number of the head-side temperature sensors 13 disposed at positions in contact with the UV ink in the ink flow path 3b may be 1, 2, 4, or more.

In the above-described embodiment, a table having a plurality of temperatures detectable by the head-side temperature sensor 13 and drive voltages associated in advance with the plurality of respective temperatures detectable by the head-side temperature sensor 13 may be stored in the controller 10 for each type of UV ink used in the printer 1. That is, a plurality of tables prepared for each type of UV ink used in the printer 1 may be stored in the controller 10.

In the above-described embodiment, the table may not be stored in the controller 10. In this case, the controller 10 performs a predetermined calculation based on the temperature detected by the head-side temperature sensor 13 to calculate the drive voltage to be applied to the piezoelectric element 16. When the controller 10 calculates the drive voltage to be applied to the piezoelectric element 16 by performing a predetermined calculation based on the temperature detected by the head-side temperature sensor 13, the controller 10 calculates a corrected voltage value corresponding to the temperature detected by the head-side temperature sensor 13 on the basis of the graph shown in FIG. 8, and calculates the drive voltage to be applied to the piezoelectric element 16 by using the calculated corrected voltage value.

In the above-described embodiment, the driver IC 17 may not be incorporated in the head 3. In this case, the driver IC 17 is implemented on a circuit board mounted on the carriage 4. Note that, even if the driver IC 17 is not incorporated in the head 3, in a case where the piezoelectric element 16 generates high heat, the temperature of the UV ink in the head 3 gradually rises due to the heat generated by the piezoelectric element 16, and the viscosity of the UV ink ejected from the nozzle 3a decreases, as the printing time of the print medium 2 after the start of printing becomes longer.

In the above-described embodiment, the controller 10 applies the drive voltage of the same magnitude to all of the piezoelectric elements 16 to be driven, but the controller 10 may not apply the drive voltage of the same magnitude to all of the piezoelectric elements 16 to be driven. In a case where the plurality of nozzles 3a constituting the nozzle row are divided into three blocks of a first nozzle block including a plurality of nozzles 3a disposed on the front side, a second nozzle block including a plurality of nozzles 3a disposed at the center in the front-rear direction, and a third nozzle block including a plurality of nozzles 3a disposed on the rear side, and a piezoelectric element set including a plurality of piezoelectric elements 16 corresponding to the nozzles 3a of the first nozzle block is defined as a first piezoelectric element set, a piezoelectric element set including a plurality of piezoelectric elements 16 corresponding to the nozzles 3a of the second nozzle block is defined as a second piezoelectric element set, and a piezoelectric element set including a plurality of piezoelectric elements 16 corresponding to the nozzles 3a of the third nozzle block is defined as a third piezoelectric element set, the controller 10 may make the drive voltage applied to the plurality of piezoelectric elements 16 constituting the third piezoelectric element set lower than the drive voltage applied to the plurality of piezoelectric elements 16 constituting the first piezoelectric element set and the plurality of piezoelectric elements 16 constituting the second piezoelectric element.

Even in this case, the controller 10 constantly monitors the temperature detected by the head-side temperature sensor 13 and controls the drive voltage applied to the piezoelectric element 16 in real time on the basis of the detection result of the head-side temperature sensor 13 so that the drive voltage applied to the piezoelectric element 16 becomes low in response to a temperature rise detected by the head-side temperature sensor 13. Specifically, the controller 10 constantly monitors the temperature detected by the head-side temperature sensor 13, and, regardless of the temperature detected by the head-side temperature sensor 13, applies, to the piezoelectric element 16, the drive voltage decreased in real time on the basis of the detection result of the head-side temperature sensor 13 so that the amount of the UV ink ejected from the nozzle 3a and the ejection speed of the UV ink ejected from the nozzle 3a become substantially constant.

In the above-described embodiment, the ejection energy generation element for ejecting UV ink from the nozzle 3a is the piezoelectric element 16, but the ejection energy generation element for ejecting UV ink from the nozzle 3a may be a heater (heat generation element). That is, in the above-described embodiment, the printer 1 ejects UV ink from the nozzle 3a by the piezo method, but the printer 1 may eject UV ink from the nozzle 3a by the thermal method.

In the above-described embodiment, a temperature sensor for controlling the in-head heater 18 may be separately provided in addition to the head-side temperature sensor 13. In the above-described embodiment, the printer 1 may include a table on which the print medium 2 is placed and a table drive mechanism that moves the table in the front-rear direction in place of the platen 8. Furthermore, in the above-described embodiment, the printer 1 may be a 3D printer, which shapes three-dimensional objects.

What is claimed is:

1. An inkjet printer that ejects an UV ink, which is an ultraviolet-curable ink, to perform printing, comprising:
an inkjet head configured to eject the UV ink;
a temperature sensor configured to detect a temperature of the UV ink inside the inkjet head; and
a controller configured to control the inkjet printer, wherein
a plurality of nozzles that eject the UV ink is provided in the inkjet head, the inkjet head includes a plurality of ejection energy generation elements configured to eject the UV ink from each of the plurality of nozzles, and
the controller is configured to perform at least one of:
constantly monitoring the temperature detected by the temperature sensor, and controlling a drive voltage applied to the ejection energy generation elements in real time on a basis of a detection result of the temperature sensor, so that the drive voltage applied to the ejection energy generation elements becomes low in response to a temperature rise detected by the temperature sensor, and
constantly monitoring the temperature detected by the temperature sensor, and controlling the drive voltage applied to the ejection energy generation elements in real time on a basis of the detection result of the temperature sensor, so that the drive voltage applied to the ejection energy generation elements becomes high in response to a temperature drop detected by the temperature sensor.

2. The inkjet printer according to claim 1, wherein the controller is configured to store a table having a plurality of temperatures detectable by the temperature sensor and the drive voltage associated in advance with each of the plurality of temperatures detectable by the temperature sensor, and
the controller is configured to apply the drive voltage associated with the temperature detected by the temperature sensor to the ejection energy generation element.

3. The inkjet printer according to claim 1, wherein the inkjet head includes a heater configured to heat the inkjet head, the temperature sensor and the heater are incorporated in the inkjet head, and the controller is configured to control the heater on a basis of a detection result of the temperature sensor.

4. The inkjet printer according to claim 2, wherein the inkjet head includes a heater configured to heat the inkjet head, the temperature sensor and the heater are incorporated in the inkjet head, and the controller is configured to control the heater on a basis of a detection result of the temperature sensor.

5. The inkjet printer according to claim 1, wherein the inkjet head includes a driver IC configured to drive the ejection energy generation element by applying the drive voltage to the ejection energy generation element, and the driver IC is incorporated in the inkjet head.

6. The inkjet printer according to claim 2, wherein the inkjet head includes a driver IC configured to drive the ejection energy generation element by applying the drive voltage to the ejection energy generation element, and the driver IC is incorporated in the inkjet head.

7. The inkjet printer according to claim 3, wherein
the inkjet head includes a driver IC configured to drive the ejection energy generation element by applying the drive voltage to the ejection energy generation element, and
the driver IC is incorporated in the inkjet head.

8. A control method of an inkjet printer, wherein the inkjet printer includes: an inkjet head configured to eject an UV ink, which is an ultraviolet-curable ink; and a temperature sensor configured to detect a temperature of the UV ink inside the inkjet head, a plurality of nozzles that eject the UV ink is provided in the inkjet head, and the inkjet head includes a plurality of ejection energy generation elements configured to eject the UV ink from each of the plurality of nozzles, and the control method comprising:
performing at least one of:
constantly monitoring the temperature detected by the temperature sensor, and controlling a drive voltage applied to the ejection energy generation elements in real time on a basis of a detection result of the temperature sensor, so that the drive voltage applied to the ejection energy generation elements becomes low in response to a temperature rise detected by the temperature sensor, and
constantly monitoring the temperature detected by the temperature sensor, and controlling the drive voltage applied to the ejection energy generation elements in real time on a basis of the detection result of the temperature sensor, so that the drive voltage applied to the ejection energy generation elements becomes high in response to a temperature drop detected by the temperature sensor.
